(19) United States
(12) Patent Application Publication
(10) Pub. No.: US 2017/0322878 A1
(43) Pub. Date: Nov. 9, 2017

(54) DETERMINE UNREFERENCED PAGE IN DEDUPLICATION STORE FOR GARBAGE COLLECTION

(71) Applicant: HEWLETT PACKARD ENTERPRISE DEVELOPMENT LP, Houston, TX (US)

(72) Inventors: Jin Wang, Fremont, CA (US); Siamak Nazari, Fremont, CA (US); Srinivasa D. Murthy, Fremont, CA (US)

(73) Assignee: HEWLETT PACKARD ENTERPRISE DEVELOPMENT LP, Houston, TX (US)

(21) Appl. No.: 15/519,921

(22) PCT Filed: Oct. 28, 2014
(86) PCT No.: PCT/US14/62622

§ 371 Date: Apr. 18, 2017

(51) Int. Cl. G06F 12/02; G06F 11/10

(52) U.S. Cl. CPC G06F 12/0253; G06F 11/1004; G06F 11/1076

(57) ABSTRACT

Examples to determine an unreferenced page in a deduplication store are disclosed. In one example implementation according to aspects of the present disclosure, a cyclic redundancy check (CRC) value is calculated for a received garbage collection data request for data on a client volume. The CRC value is translated into a physical page location in a deduplication store for the client volume using a three-level table scheme. It is then determined whether a physical page in the deduplication store is unreferenced.

### BACKGROUND

The amount and size of electronic data consumers and companies generate and use continues to grow in size and complexity, as does the size and complexity of related applications. In response, data centers housing the growing and complex data and related applications have begun to implement a variety of networking and server configurations to provide storage of and access to the data.

### BRIEF DESCRIPTION OF THE DRAWINGS

The following detailed description references the drawings, in which:

FIG. 1 illustrates a block diagram of a computing system determine an unreferenced page in a deduplication store according to examples of the present disclosure;

FIG. 2 illustrates a block diagram of another computing system determine an unreferenced page in a deduplication store according to examples of the present disclosure;

FIG. 3 illustrates a block diagram of a non-transitory computer-readable storage medium for a computing system storing instructions to determine an unreferenced page in a deduplication store according to examples of the present disclosure;

FIG. 4 illustrates a flow diagram of a method to determine an unreferenced page in a deduplication store according to examples of the present disclosure;

FIG. 5 illustrates a flow diagram of a method to determine an unreferenced page in a deduplication store according to examples of the present disclosure; and

FIG. 6 illustrates a block diagram of a three-level table scheme according to examples of the present disclosure.

### DETAILED DESCRIPTION

As users generate and consume greater amounts of data, the storage demands for these data also increase. Larger volumes of data become increasingly expensive, time consuming, and space consuming to store and access. Moreover, the amount of duplicate data, that is, data that is the same as previously existing data, is common. Such duplicate data further taxes storage resources.

Data deduplication (i.e., detecting duplicate data) in primary block-based storage arrays is increasingly useful with the addition of solid state disks (SSDs) to the supported media in these arrays. The cost differential between SSDs and traditional hard disk drives utilizes solutions like deduplication and compression to reduce the cost per byte of these storage arrays. Primary storage arrays demand the high performance placed on them by host operating systems in terms of low latency and high throughput.

With storage capacities growing increasingly larger, finding duplicate data is a scaling problem that places demands on the central processing unit (CPU) and memory of the storage controllers of the storage arrays. The impact of deduplication on input/output performance is determined by various parameters, such as whether data is deduplicated inline or in the background as well as the granularity of deduplication. Deduplicating data at a smaller granularity (such as 16 kilobyte pages) in block-based storage systems, while providing better space savings, requires an increase in CPU processing and memory. Some primary block-based storage arrays are not capable of handling the conflicting demands of input/output performance with inline data deduplication, and consequently resort to background deduplication. Some storage arrays also address deduplication by deduplicating data in larger chucks (such as multiple gigabytes at a time). In other examples, data duplication was detected, for example, using cryptographic hashes to determine duplicate data. These cryptographic hashes utilize more space to store and more processing resources to compare.

In a block-based storage system with deduplication functionality, multiple client pages can point to the same deduplicated page in a deduplication store. When the client pages are modified, the client pages stop pointing to the previous page in the deduplication store and instead point elsewhere. When all of the client pages stop pointing to a particular page in the deduplication store, the page in the deduplication store is no longer referenced and can be freed. Therefore, tracking pointers to a page in the deduplication store, and freeing those pages when the page in the deduplication store is no longer in use is a fundamental problem in deduplicated block-based storage systems. One way this can be overcome is by actively maintaining reference counts and freeing pages when the reference count decreases to zero. This is known as a “mark and sweep” technique. However, maintaining reference counts in a fault-tolerant and atomic manner when the deduplication client and storage volume are on different computing entities of a shared, distributed, block-based storage system is complicated.

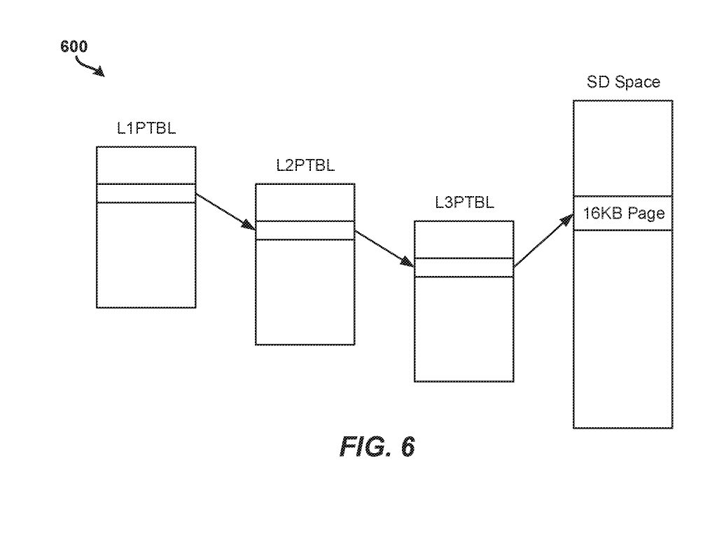

Various implementations are described below by referring to several examples to determine an unreferenced page in a deduplication store are disclosed. In one example implementation according to aspects of the present disclosure, a cyclic redundancy check (CRC) value is calculated for a received garbage collection data request for data on a client volume. The CRC value is translated into a physical page location in a deduplication store for the client volume using a three-level table scheme, such as illustrated in FIG. 6 and described below. It is then determined whether a physical page in the deduplication store is unreferenced. In one example, the determination of whether a physical page in the deduplication store is based on the translated CRC value by comparing the translated CRC value to a plurality of existing CRC values stored in the deduplication store. In another example, the determination is based on an absence of direct references to the physical page by comparing the translated CRC value to a plurality of existing CRC values stored in the deduplication store.

In some implementations, the described techniques obviate the need for the traditionally complicated implementation of maintaining reference counts. For example, the techniques described here in detect the blocks in a deduplication store that have their pointers re-written (i.e., blocks that are no longer in use). The blocks can then be freed to become free standing blocks, which are then reusable. The present techniques do not rely on existing “mark and sweep” techniques, nor do they require that the volumes be taken offline. Fault-tolerance requirements are also simplified. Additionally, if a particular computing entity becomes unavailable during the garbage collection process of the present disclosure, a subsequent garbage collection execution may reclaim any unused space. These and other advantages will be apparent from the description that follows.

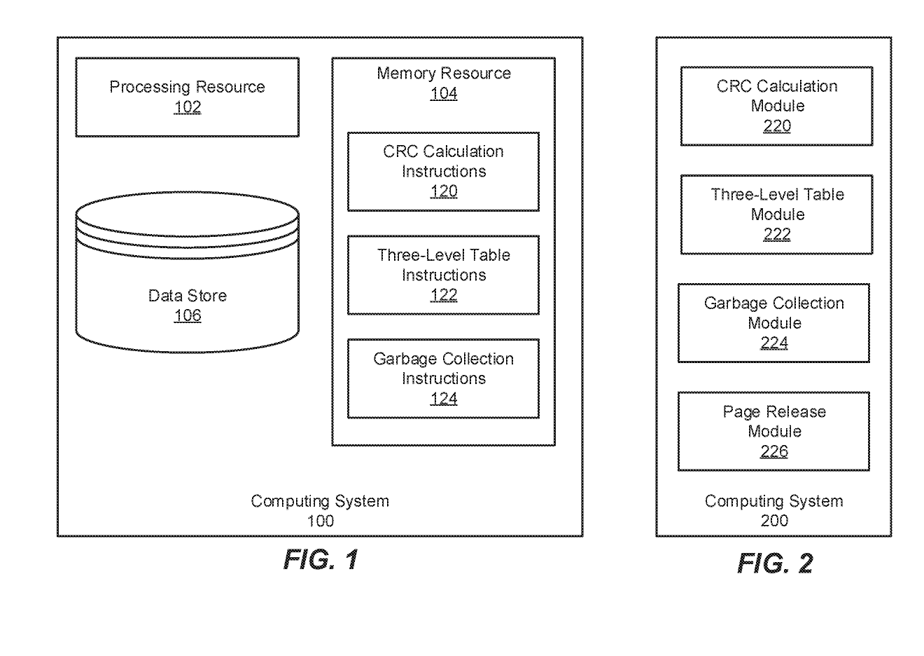

FIGS. 1-3 include particular components, modules, etc. according to various examples as described herein. In different implementations, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Generally, FIGS. 1-3 relate to components and modules of a computing system, such as computing system 100 of FIG. 1 and computing system 200 of FIG. 2. It should be understood that the computing systems 100 and 200 may include any appropriate type of computing system and/or computing device, including for example smartphones, tablets, desktops, laptops, workstations, servers, smart monitors, smart televisions, digital signage, scientific instruments, retail point of sale devices, video walls, imaging devices, peripherals, networking equipment, or the like.

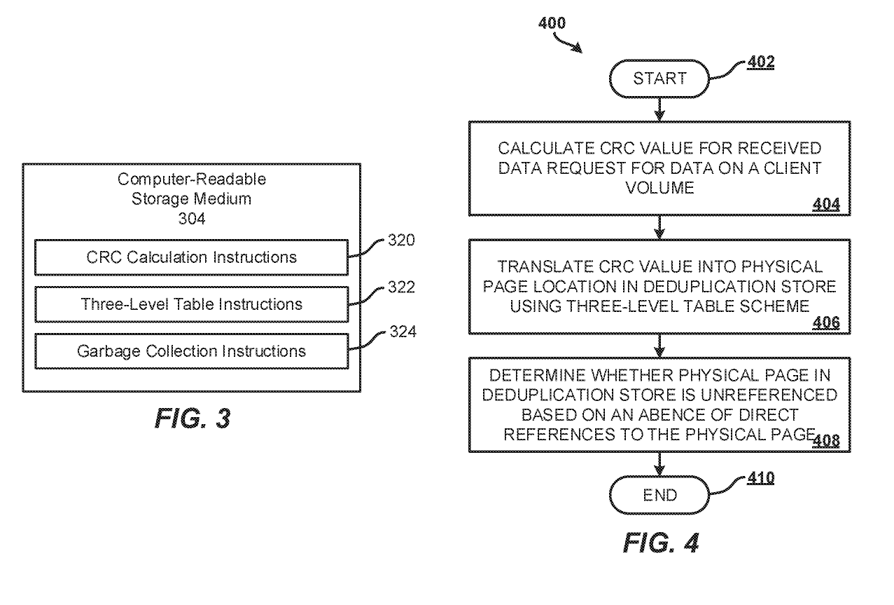

FIG. 1 illustrates a block diagram of a computing system 100 determine an unreferenced page in a deduplication store according to examples of the present disclosure. The computing system 100 may include a processing resource 102 that represents generally any suitable type or form of processing unit or units capable of processing data or interpreting and executing instructions. The processing resource 102 may be one or more central processing units (CPUs), microprocessors, and/or other hardware devices suitable for retrieval and execution of instructions. The instructions may be stored, for example, on a non-transitory tangible computer-readable storage medium, such as memory resource 104 (as well computer-readable storage medium 304 of FIG. 3), which may include any electronic, magnetic, optical, or other physical storage device that store executable instructions. Thus, the memory resource 104 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions may be stored during runtime, and a secondary memory, such as a nonvolatile memory in which a copy of the instructions is stored.

Alternatively or additionally, the computing system 100 may include dedicated or discrete hardware, such as one or more integrated circuits, Application Specific Integrated Circuits (ASICs), Application Specific Special Processors (ASSPs), Field Programmable Gate Arrays (FPGAs), or any combination of the foregoing examples of dedicated or discrete hardware, for performing the techniques described herein. In some implementations, multiple processing resources (or processing resources utilizing multiple processing cores) may be used, as appropriate, along with multiple memory resources and/or types of memory resources.

Additionally, the computing system 100 may include cyclic redundancy check (CRC) instructions 120, three-level table instructions 122, and garbage collection instructions 124. The instructions 120, 122, 124 may be processor executable instructions stored on a tangible memory resource such as memory resource 104, and the hardware may include processing resource 102 for executing those instructions. Thus memory resource 104 can be said to store program instructions that when executed by the processing resource 102 implement the modules described herein. Other instructions may also be utilized as will be discussed further below in other examples.

In examples, as illustrated in FIG. 1, the computing system 100 includes a storage device or array of storage devices, such as data store 106, which may store data including an operating system or operating systems, a client volume, and a deduplication store. Certain operating systems provide the ability to configure various virtual volumes on the data store 106 and distribute the virtual volumes across multiple systems. It should be understood that the data store 106 may reside at the computing system 100 and/or remotely from the computing system 100 and may include multiple storage devices or arrays of storage devices.

Host may access these volumes on the data store 106 using, for example, SCSI commands, providing a LUN identifier, a logical block address (LBA), and a length of an input/output (I/O) operation. In some implementations, a volume type may be a thin provisioned virtual volume—that is, a virtual volume created using a process for optimizing utilization of available storage using on-demand allocation of blocks of data versus the traditional method of allocating the blocks initially. In the case of thin provisioned virtual volumes, data being accessed by a host is located using a three-level page table translation mechanism.

A client volume or client volumes may be generated and stored in the data store 106. In examples, the client volume may be multiple virtual thin provision virtual volumes acting as a distributed system.

Additionally, a data deduplication store may be generated and stored in the data store 106. The data deduplication store (or dedupe store) is a thin provisioned virtual volume used to detect duplicate data and minimize the duplicate data's size by deduplicating the data. As a result of the data deduplication process, pages within the deduplication store may be used to store data along with a CRC value for each of the pages. Pointer references in a three-level page table point to pages within the deduplication store where data is located. It is desirable to detect and release pages that are no longer used (i.e., pages to which no reference points). This is known as a garbage collection process. By performing the garbage process, efficiency within the deduplication store is increased, and the deduplication store requires less space for the deduplication store thin provision virtual volume. To perform the garbage collection process to detect and release the unreferenced pages, the computing system 100 utilizes the instructions 120, 122, 124.

Specifically, the CRC calculation instructions 120 calculate a cyclic redundancy check (CRC) value or signature for a received garbage collection data request for data on a client volume (e.g., the data store 106). For example, the CRC instructions 120 calculate a CRC value (or signature) of the incoming data. Once the CRC value (or signature) of the incoming garbage collection data request is calculated by the CRC module 110, the CRC value is compared to the CRC value for existing pages already stored in the dedupe store (such as data store 106 of FIG. 1).

In examples, the CRC instructions 120 may be stored in a dedicated hardware module or offload engine that can compute the CRC of the garbage collection received data request using, for example, the CRC32 algorithm. In other examples, the dedicated hardware implementation of the CRC instructions 120 may compute the CRC value using higher precision hashes of data, such as the SHA-2 algorithm. Consequently, by offloading the traditionally processing resource intensive CRC value calculations to a dedicated hardware module, the processing resource (such as processing resource 102) is relived of performing the processing intensive calculations.

Once the CRC value or signature of the incoming data is computed by the CRC instructions 120, the three-level table instructions 122 translates the CRC value into a physical page location or logical block address of the deduplication store by performing a three-level translation, also known as a three-level page table scheme or walk. When the CRC value is computed for a page, the computed CRC is used as the page offset into the data dedupe store thin provision virtual volume. The three-level table scheme is performed to translate the CRC value into a physical page location by the three-level table instructions 122, and the data is then stored at the appropriate location within the deduplication store based on the three-level page table scheme.

The garbage collection instructions 124 may initiate the garbage collection. The garbage collection may be initiated at a predetermined time, by a system administrator, or at another suitable time. The garbage collection process may also be initiated iteratively, as the physical pages may be continually changing and becoming unreferenced. Regardless of the time, however, the garbage collection process performed by the garbage collection instructions 124 may be performed while the data store 106 remains online. In particular, the virtual client volume or volumes visible to clients remain accessible to the clients during the garbage collection process, as does the deduplication store. The deduplication store is notified to track new additions to the deduplication store once the garbage collection process begins.

The garbage collection instructions 124 determine whether a physical page in the deduplication store is unreferenced based on an absence of direct references to the physical page by comparing the translated CRC value to a plurality of existing CRC values stored in the deduplication store. This may be further accomplished by the garbage collection instructions 124 scanning the client volumes to collect the CRC values, which act as identifiers, of the pages in the deduplication store that the clients are using. The collected CRC values are then sent to the deduplication store and may be merged with any new page identifiers created during the garbage collection process.

A physical page in the deduplication store is unreferenced when it is determined that an absence of direct references to the physical page in the deduplication store exists. These unreferenced pages may be released in the deduplication store. In examples, the computing system 100 may include instructions to release the unreferenced physical page in the deduplication store. This enables the unreferenced pages to be freed or released so that the physical pages may be used to write new data. However, a physical page in the deduplication store is not unreferenced when an absence of direct references to the physical page in the deduplication store does not exist. In this case, the physical page is not freed and the physical page remains unchanged.

FIG. 2 illustrates a block diagram of another computing system determine an unreferenced page in a deduplication store according to examples of the present disclosure. The computing system 200 may include a CRC calculation module 220, a three-level table module 222, an unreferenced module 224, and a page release module 226.

In examples, the modules described herein may be a combination of hardware and programming instructions. The programming instructions may be processor executable instructions stored on a tangible memory resource such as a memory resource, and the hardware may include a processing resource for executing those instructions. Thus the memory resource can be said to store program instructions that when executed by the processing resource implement the modules described herein. Other modules may also be utilized as will be discussed further below in other examples. In different implementations, more, fewer, and/or other components, modules, instructions, and arrangements thereof may be used according to the teachings described herein. In addition, various components, modules, etc. described herein may be implemented as computer-executable instructions, hardware modules, special-purpose hardware (e.g., application specific hardware, application specific integrated circuits (ASICs), and the like, or some combination or combinations of these.

The CRC calculation module 220 calculate a cyclic redundancy check (CRC) value or signature for a garbage collection received data request for data on a client volume. Once the CRC value or signature of the incoming data is computed by the CRC calculation module 222, the three-level table module 222 translates the CRC value into a physical page location or logical block address of the deduplication store by performing a three-level table scheme.

The garbage collection module 224 then initiates the garbage collection process to determine whether a physical page in the deduplication store is unreferenced based an absence of direct references to the physical page by comparing the translated CRC value to a plurality of existing CRC values stored in the deduplication store.

In an example, a physical page in the deduplication store is unreferenced when the garbage collection module 224 determines that an absence of direct references to the physical page in the deduplication store exists. Conversely, a physical page in the deduplication store is not unreferenced when the garbage collection module 224 determines that an absence of direct references to the physical page in the deduplication store does not exist. These unreferenced pages may be released in the deduplication store. In examples, the computing system 100 may include instructions to release the unreferenced physical page in the deduplication store. This enables the unreferenced pages to be freed or released by the page release module 226 so that the physical pages may be used to write new data. In particular, the page release module 226 may then release the unreferenced physical page in the deduplication store when it is determined that the physical page in the deduplication store is unreferenced.

In another example, a physical page in the deduplication store is unreferenced when it is determined that the translated CRC value does not match at least one of the existing CRC values stored in the deduplication store. However, a physical page in the deduplication store is not unreferenced when the translated CRC value matches at least one of the existing CRC values stored in the deduplication store. In this case, the physical page is not freed by the page release module 226 and the physical page remains unchanged.

FIG. 3 illustrates a block diagram of a non-transitory computer-readable storage medium 304 for a computing system storing instructions to determine an unreferenced page in a deduplication store according to examples of the present disclosure. The computer-readable storage medium 304 is non-transitory in the sense that it does not encompass a transitory signal but instead is made up of one or more memory components configured to store the instructions. The computer-readable storage medium may be representative of the memory resource 104 of FIG. 1 and may store machine executable instructions in the form of modules, which are executable on a computing system such as computing system 100 of FIG. 1 and/or computing system 200 of FIG. 2.

In the example shown in FIG. 3, the instructions may include cyclic redundancy check (CRC) instructions 320, three-level table instructions 322, and garbage collection instructions 324. The instructions 320, 322, 324 of the computer-readable storage medium 304 may be executable so as to perform the techniques described herein, including the functionality described regarding the method 400 of FIG. 4. While the functionality of the instructions 320, 322, 324 is described below with reference to the functional blocks of FIG. 4, such description is not intended to be so limiting.

In particular, FIG. 4 illustrates a flow diagram of a method 400 to determine an unreferenced page in a deduplication store according to examples of the present disclosure. The method 400 may be stored as instructions on a non-transitory computer-readable storage medium such as computer-readable storage medium 304 of FIG. 3 or another suitable memory such as memory resource 104 of FIG. 1 that, when executed by a processor (e.g., processing resource 102 of FIG. 1), cause the processor to perform the method 400. It should be appreciated that the method 400 may be executed by a computing system or a computing device such as computing system 100 of FIG. 1 and/or computing system 200 of FIG. 2.

At block 402, the method 400 begins and continues to block 404. At block 404, the CRC calculation instructions 320 calculate cyclic redundancy check (CRC) value for a received garbage collection data request for data on a client volume. The method 400 continues to block 406.

At block 406, the three-level table instructions 322 translate the CRC value into a physical page location in a deduplication store for the client volume using a three-level table scheme. The method 400 continues to block 408.

At block 408, the garbage collection instructions 324 determine whether a physical page in the deduplication store is unreferenced based on an absence of direct references to the physical page by comparing the translated CRC value to a plurality of existing CRC values stored in the deduplication store. For example, it may be determined that the physical page in the deduplication store is unreferenced when an absence of direct references to the physical page in the deduplication store exists. Similarly, it may be determined that the physical page in the deduplication store is not unreferenced when an absence of direct references to the physical page in the deduplication store does not exist. The garbage collection instructions 324 may determine whether a physical page is unreferenced iteratively.

Additional processes also may be included. For example, the method 400 may include release the unreferenced physical page in the deduplication store when it is determined that an absence of direct references to the physical page in the deduplication store exists. It should be understood that the processes depicted in FIG. 4 represent illustrations, and that other processes may be added or existing processes may be removed, modified, or rearranged without departing from the scope and spirit of the present disclosure.

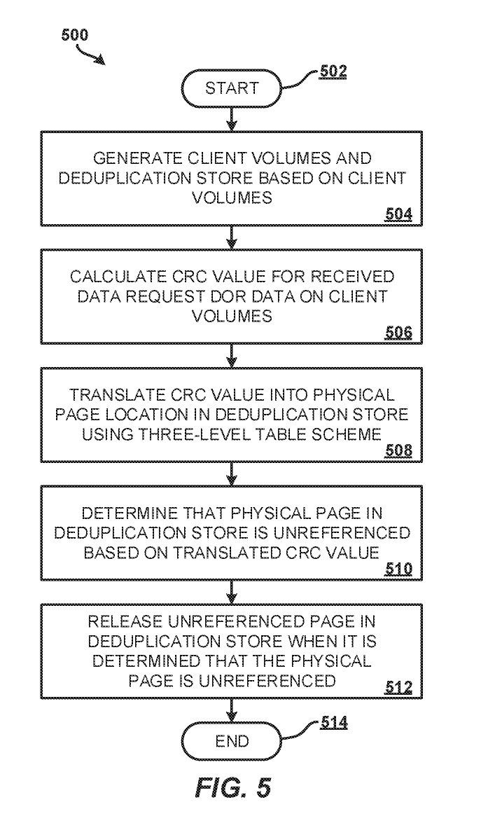

FIG. 5 illustrates a flow diagram of a method 500 to determine an unreferenced page in a deduplication store according to examples of the present disclosure. The method 500 may be executed by a computing system or a computing device such as computing system 100 of FIG. 1 and/or computing system 200 of FIG. 2. The method 500 may also be stored as instructions on a non-transitory computer-readable storage medium such as computer-readable storage medium 304 of FIG. 3 that, when executed by a processor (e.g., processing resource 102 of FIG. 1), cause the processor to perform the method 500.

At block 502, the method 500 begins and continues to block 504. At block 504, the method 500 includes a computing system (e.g., computing system 100 of FIG. 1 and/or computing system 200 of FIG. 2) generating a plurality of client volumes and a deduplication store based on the plurality of client volumes. The method 500 then continues to block 506.

At block 506, the method 500 includes the computing system calculates cyclic redundancy check (CRC) value for a received garbage collection data request for data on the plurality of client volumes. In examples, calculating the cyclic redundancy check value is performed by a first discrete hardware component of the computing system. The method 500 then continues to block 508.

At block 508, the method 500 includes the computing system translates the CRC value into a physical page location in a deduplication store for the plurality of client volumes using three-level table scheme. The method 500 then continues to block 510.

At block 510, the method 500 includes the computing system determines whether a physical page in the deduplication store is unreferenced based on the translated CRC value by comparing the translated CRC value to a plurality of existing CRC values stored in the deduplication store. In examples, comparing the translated CRC value to a plurality of existing CRC values stored in the deduplication store utilizes an XOR operation. Additionally, translating the CRC value into a physical page location in the deduplication store using the three-level table walk may use the CRC value as a logical block address for the three-level table walk. The method 500 then continues to block 512.

At block 510, the method 500 includes the computing system releases the unreferenced page in the deduplication store when it is determined that the physical page in the deduplication store is unreferenced.

Additional processes also may be included. In examples, the plurality of client volumes and the deduplication store remain online during the calculating, translating, determining, and releasing. It should be understood that the processes depicted in FIG. 5 represent illustrations, and that other processes may be added or existing processes may be removed, modified, or rearranged without departing from the scope and spirit of the present disclosure.

FIG. 6 illustrates a block diagram of a three-level table scheme 600 according to examples of the present disclosure. In an example, such as shown in FIG. 2, the thin provisioned volumes use 16 kilobyte allocation units, although other sizes may be utilized in different examples. These allocation units may use standard file system techniques, such as bitmaps and three-level block pointers. Input/output data requests targeted to a thin provisioned volume is translated by looking up the region in the volume to see if the area being written or read has previously been written. A “write” request to a region that has not been previously written may allocate backing storage and associate it with a virtual address of the thin provisioned volume. In the example shown in FIG. 2, the granularity of the three-level page lookup and allocation is 16 KB. In this example, the space of the thin provisioned volume is represented using a three-level page table system, referred to as L1PTBL, L2PTBL, and L3PTBL. The first and second tables (L1PTBL and L2PBTL) contain pointers to the next level page tables. For example, L1PTBL contains a pointer to a location at L2PTBL, and L2PTBL contains a pointer to a location at L3PTBL. The level three page table (L3PTBL) contains pointers to actual disk pages that provide the 16 KB of backing store for the corresponding virtual thin provisioned volume offset.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium storing instructions that, when executed by a processor, cause the processor to:
calculate cyclic redundancy check (CRC) value for a received garbage collection data request for data on a client volume;
translate the CRC value into a physical page location in a deduplication store for the client volume using a three-level table scheme; and
determine whether a physical page in the deduplication store is unreferenced based on an absence of direct references to the physical page by comparing the translated CRC value to a plurality of existing CRC values stored in the deduplication store.

2. The non-transitory computer-readable storage medium of claim 1, further storing instructions that, when executed by the processor, cause the processor to:
release the unreferenced physical page in the deduplication store when it is determined that an absence of direct references to the physical page in the deduplication store exists.

3. The non-transitory computer-readable storage medium of claim 1, wherein it is determined that the physical page in the deduplication store is unreferenced when an absence of direct references to the physical page in the deduplication store exists.

4. The non-transitory computer-readable storage medium of claim 1, wherein it is determined that the physical page in the deduplication store is not unreferenced when an absence of direct references to the physical page in the deduplication store does not exist.

5. The non-transitory computer-readable storage medium of claim 1, wherein the determining whether a physical page in the deduplication store is unreferenced is performed iteratively.

6. A block-based storage system comprising:
a cyclic redundancy check (CRC) module to calculate a CRC value for a received garbage collection data request for data on a client volume;
a three-level table module to translate the CRC value into a physical page location in a deduplication store for the client volume using a three-level table scheme;
a garbage collection module to determine whether a physical page in the deduplication store is unreferenced based on an absence of direct references to the physical page by comparing the translated CRC value to a plurality of existing CRC values stored in the deduplication store when the client volume is online; and
a page release module to release the unreferenced page in the deduplication store when it is determined that the physical page in the deduplication store is unreferenced.

7. The block-based storage system of claim 6, wherein the garbage collection module iteratively performs the determining whether the physical page in the deduplication store is unreferenced.

8. The block-based storage system of claim 6, wherein the client volume further comprises a plurality of client volumes as a distributed system.

9. The block-based storage system of claim 6, the garbage collection module determines that the physical page in the deduplication store is unreferenced when an absence of direct references to the physical page in the deduplication store exists.

10. The block-based storage system of claim 6, wherein the garbage collection module determines that the physical page in the deduplication store is not unreferenced an absence of direct references to the physical page in the deduplication store does not exist.

11. A method comprising:
generating, by a computing system, a plurality of client volumes and a deduplication store based on the plurality of client volumes;
calculating, by the computing system, cyclic redundancy check (CRC) value for a received garbage collection data request for data on the plurality of client volumes;
translating, by the computing system, the CRC value into a physical page location in a deduplication store for the plurality of client volumes using three-level table scheme;
determining, by the computing system, whether a physical page in the deduplication store is unreferenced based on the translated CRC value by comparing the translated CRC value to a plurality of existing CRC values stored in the deduplication store; and
releasing, by the computing system, the unreferenced page in the deduplication store when it is determined that the physical page in the deduplication store is unreferenced.

12. The method of claim 11, wherein the plurality of client volumes and the deduplication store remain online during the calculating, translating, determining, and releasing.

13. The method of claim 11, wherein calculating the cyclic redundancy check value is performed by a first discrete hardware component of the computing system.

14. The method of claim 11, wherein comparing the translated CRC value to a plurality of existing CRC values stored in the deduplication store utilizes an XOR operation.

15. The method of claim 11, wherein translating the CRC value into a physical page location in the deduplication store using the three-level table walk includes using the CRC value as a logical block address for the three-level table walk.
